(19) United States
(12) Patent Application Publication
(10) Pub. No.: US 2021/0241194 A1
(43) Pub. Date: Aug. 5, 2021

(54) SYSTEMS AND METHODS FOR CONNECTING MANAGEMENT SYSTEMS THROUGH SCALE TICKET DATA

(71) Applicant: Caterpillar Inc., Peoria, IL (US)

(72) Inventors: Gautham Subramanian, Peoria, IL (US); Chad T. Brickner, Dunlap, IL (US)

(73) Assignee: Caterpillar Inc., Peoria, IL (US)

(21) Appl. No.: 16/782,317

(22) Filed: Feb. 5, 2020

(51) Int. Cl. G06Q 10/06; G06Q 50/04; G06Q 10/08; G06Q 10/10; H04W 4/029

(52) U.S. Cl. CPC G06Q 10/06312; G06Q 50/04; G06Q 10/0838; H04W 4/029; G06Q 10/08355; G06Q 10/109; G06Q 10/087

(57) ABSTRACT

A method includes receiving, from a material plant management system, check-in data for a haul truck that has checked into a material plant, the check-in data including a haul truck identifier and a check-in time. The method further includes receiving, from the material plant management system, scale ticket data including a destination of the haul truck and a check-out time at which the haul truck exits the material plant with a load of material, sending, via a network, the scale ticket data to a haul truck management system associated with the haul truck and a worksite management system associated with the destination, determining, based on the check-out time and the destination, an estimated time of arrival representing a time at which the haul truck will reach the destination, and providing, via the network, the estimated time of arrival to the haul truck management system and the worksite management system.

### TECHNICAL FIELD

The present disclosure relates to a system for connecting a material supplier to a customer. More specifically, the present disclosure relates to systems and methods for connecting a material supplier system to a customer system using scale ticket data generated at a material plant.

### BACKGROUND

Worksite management often requires coordination of machinery, materials, outside suppliers, hauling companies, and/or contractors (among others). Supervisors, such as job foremen or other worksite managers, may track progress of the many machines, operators, and materials that are associated with the worksite. In order to operate efficiently, a supervisor needs to coordinate completion of tasks based on available equipment, workers, and materials. For example, if a worksite unexpectedly runs out of materials needed to complete a task, operations at the worksite may be delayed waiting on material. Additionally, if a supplier of a material is unable to provide the material on time, progress at the worksite may be delayed. Therefore, worksite efficiency depends directly upon, among other factors, management of a workforce (e.g., operators, workers, etc.), having an adequate and consistent supply of materials needed to complete various tasks, and coordination of outside suppliers or contractors.

In order to improve and/or track worksite efficiency, supervisors or other jobsite workers often utilize various tools to monitor worksite equipment, material delivery, machine operators, etc. Such tools may track the progress of tasks being performed at the worksite. However, if a scheduled material delivery at a worksite from a material supplier is delayed, the supervisor may be unaware, and existing tools fail to provide an effective way of identifying and tracking such delays.

For example, U.S. Pat. No. 8,306,731 (hereinafter referred to as the '731 reference) describes a system for assessing the productivity and progress of workers employing vehicles at worksites. The '731 reference describes productivity measurements that may be combined with geographical information so as to provide productivity measurements in a geographical context. The system described in the '731 reference does not, however, provide the ability to track progress of other entities that may be involved in various tasks associated with a worksite. As a result, worksite supervisors using such a system may be unable to properly coordinate the completion of various tasks associated with a worksite.

Example embodiments of the present disclosure are directed toward overcoming the deficiencies described above.

### SUMMARY

An example method includes receiving, with a controller and from a material plant management system in communication with the controller, check-in data for a haul truck that has checked into a material plant, the check-in data including a haul truck identifier, a check-in time representing a time at which the haul truck checked into the material plant, and a haul company associated with the haul truck. The method further includes ending, via a network, the check-in data to a haul truck management system associated with the haul company and in communication with the controller, receiving, with the controller and from the material plant management system, scale ticket data including a quantity of material loaded on the haul truck, a destination of the haul truck, a customer associated with the destination, and a check-out time indicating a time at which the haul truck leaves the material plant with the material, and sending, via the network, the scale ticket data to the haul truck management system and a worksite management system associated with the customer and in communication with the controller. The method also includes r determining, with the controller and based on the check-out time, information representing an estimated time of arrival representing a time at which the haul truck will reach the destination, and providing, with the controller and via the network, the estimated time of arrival to the worksite management system and the haul truck management system.

An example system includes one or more processors and non-transitory computer-readable media storing instructions that, when executed by the one or more processors, causes the one or more processors to perform operations comprising receiving, from a material plant management system, check-in data for a haul truck that has checked into a material plant, the check-in data including a haul truck identifier and a check-in time. The operations further include receiving, from the material plant management system, scale ticket data including a destination of the haul truck and a check-out time at which the haul truck exits the material plant with a load of material, and sending, via a network, the scale ticket data to a haul truck management system associated with the haul truck and a worksite management system associated with the destination. The operations further include determining, based on the check-out time and the destination, an estimated time of arrival representing a time at which the haul truck will reach the destination, and providing, via the network, the estimated time of arrival to the haul truck management system and the worksite management system.

In a further example, a system includes a controller, at least one haul truck, and a network, wherein the controller is configured to perform operations including receiving, from a material plant management system in communication with the controller, check-in data for a haul truck that has checked into a material plant, the check-in data including a haul truck identifier, and a check-in time representing a time at which the haul truck checked into the material plant. The operations further include receiving, from the material plant management system, scale ticket data including a destination of the haul truck, a type of material loaded on the haul truck, a quantity of material loaded on the haul truck, and a check-out time indicating a time at which the haul truck exits the material plant, and sending, via the network, the haul truck identifier and the destination to a haul truck management system associated with the haul truck. The operations also include determining, with the controller and based on the check-out time, an estimated time of arrival representing a time at which the haul truck will arrive at the destination, and providing, via the network, the estimated time of arrival, the type of material, and the quantity of material, to a worksite management system associated with the destination.

### BRIEF DESCRIPTION OF DRAWINGS

FIG. 1 is a schematic illustration of a worksite system in accordance with an example of the present disclosure.

FIG. 2 is an example framework for connecting various management systems in accordance with an example of the present disclosure.

FIG. 3 is an example architecture of a system connecting various management systems in accordance with an example of the present disclosure.

FIG. 4 is a schematic illustration of components associated with a worksite system in accordance with an example of the present disclosure.

FIG. 5 is flowchart illustrating an example method of connecting various management systems in accordance with an example of the present disclosure.

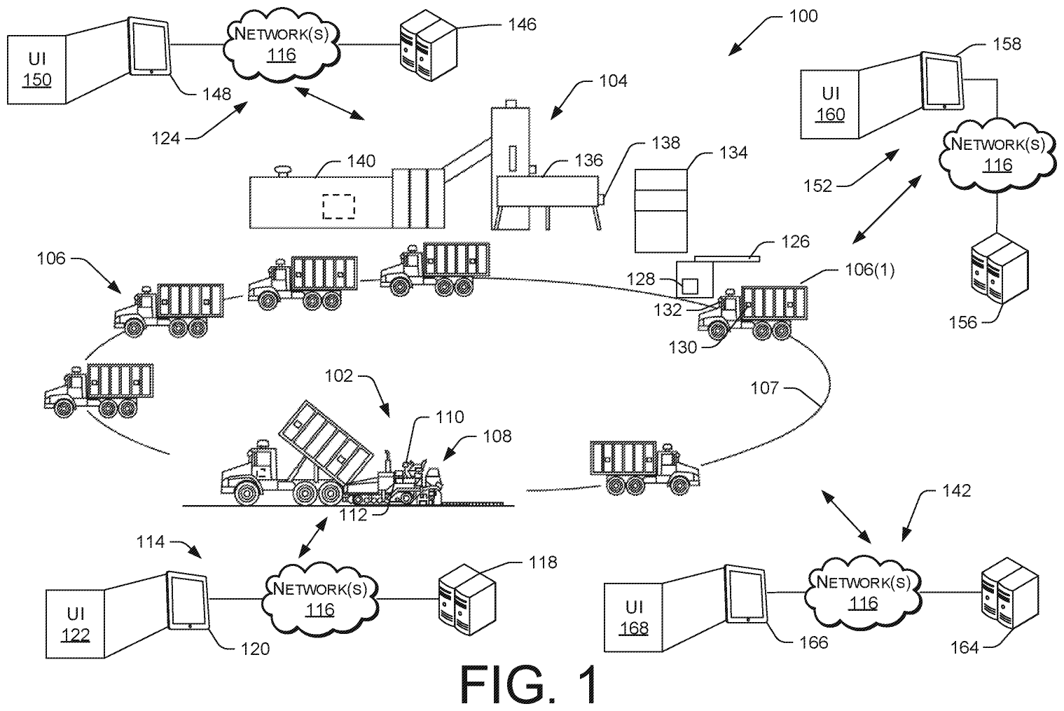

### DETAILED DESCRIPTION

Wherever possible, the same reference numbers will be used throughout the drawings to refer to the same or like parts. Referring to FIG. 1, an example worksite system 100 may include various entities that coordinate with one another in order to complete various tasks associated with a worksite 102. For example, the worksite system 100 may include a first entity (referred to herein as “a customer”) associated with the worksite 102. The customer may manage a specific job and/or jobs associated with the worksite 102. For example, the customer may manage a worksite 102 associated with a paving project, excavation project, mining project, etc. In some examples, the customer may manage multiple worksites. The worksite system 100 may also include a second entity (also referred to herein as “a supplier”) that may supply materials and/or other items to the customer. In some examples, the supplier may be associated with a material plant 104. The material plant 104 may include a quarry yard, lumberyard, gravel pit, a paving material plant, or any other material plant. In some examples, the customer may purchase material from the supplier. Additionally, the supplier may be associated with multiple material plants that supply a same or different material. Alternatively, in some examples, the worksite system 100 may include multiple suppliers that supply different types of material. For example, a first supplier may supply a first material (e.g., lumber), while a second supplier may supply a second material (e.g., gravel).

Furthermore, the worksite system 100 may further include a third entity (also referred to herein as “a haul company”) that is responsible for hauling material and/or other items between the worksite 102, the material plant 104, and/or other locations. As such, one or more haul trucks 106 may be associated with and managed by the haul company. The haul trucks 106 may traverse a path 107 between the worksite 102, the material plant 104, and/or other locations. The worksite 102, the material plant 104, and the haul trucks 106 may be associated with same or different entities (e.g., the customer, the supplier, and the haul company) Furthermore, while describing the worksite system 100 as having entities associated with the worksite 102, the material plant 104, and the haul trucks 106, in some examples, the worksite system 100 may include various other components (e.g., machinery, plants, contractors, etc.) that may be associated with the entities described above or other entities associated with the other components.

As mentioned above, the worksite system 100 may include a worksite 102 associated with a job or multiple jobs that are completed in order to complete a project. FIG. 1 depicts a worksite 102 that may be associated with any type of construction project, foresting project, mining project, paving project, etc. As such, the worksite 102 may include various types of machinery (represented by machine 108) that complete jobs and/or tasks at the worksite 102. The machine 108 may include any type of worksite machinery such as paving machines, compactors, excavators, dump trucks, loaders, backhoes, pipelayers, etc. In some examples, the machine 108 of the worksite 102 may include a controller 110 (or multiple controllers). In some examples, the controller 110 may be in communication with various sensors 112 of the machine 108. The controller 110 may track, via the sensors 112, progress, location, and/or other metrics indicating attributes of the machine 108 as the machine 108 moves and works about the worksite 102.

The controller 110 may provide such metrics and other data to a worksite management system 114 associated with the worksite 102 via a network 116. The network 116 may be a local area network (“LAN”), a larger network such as a wide area network (“WAN”), or a collection of networks, such as the Internet. Protocols for network communication, such as TCP/IP, may be used to implement the network 116. Although embodiments are described herein as using a network 116 such as the Internet, other distribution techniques may be implemented that transmit information via memory cards, flash memory, or other portable memory devices. Although embodiments are described herein as using a network 116 such as the Internet, other distribution techniques may be implemented that transmit information via memory cards, flash memory, or other portable memory devices. From such data, the worksite management system 114 may track progress of machines and various tasks associated with the worksite 102.

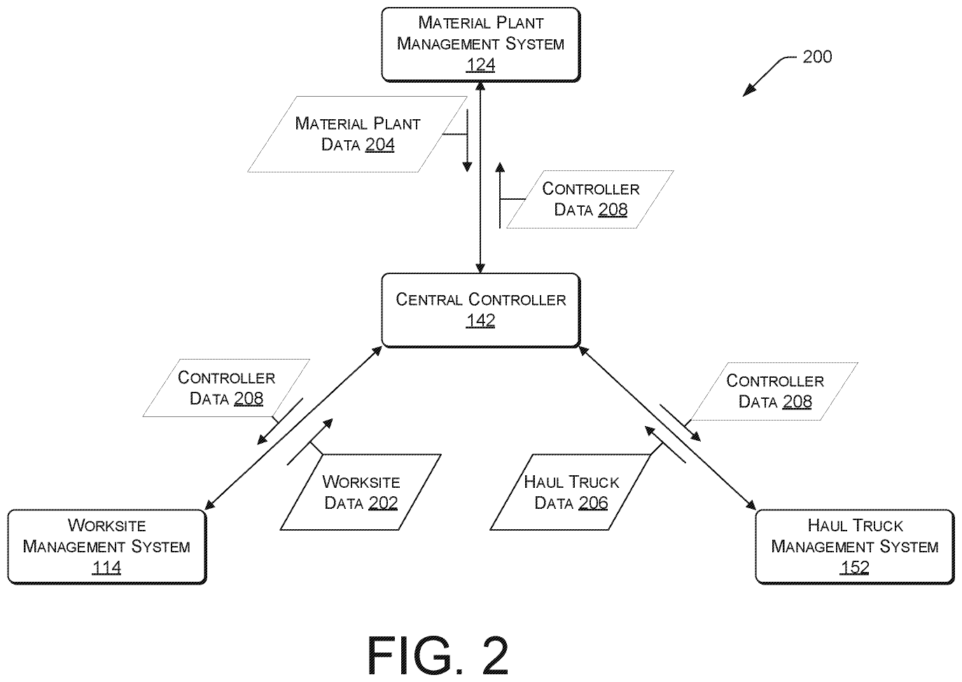

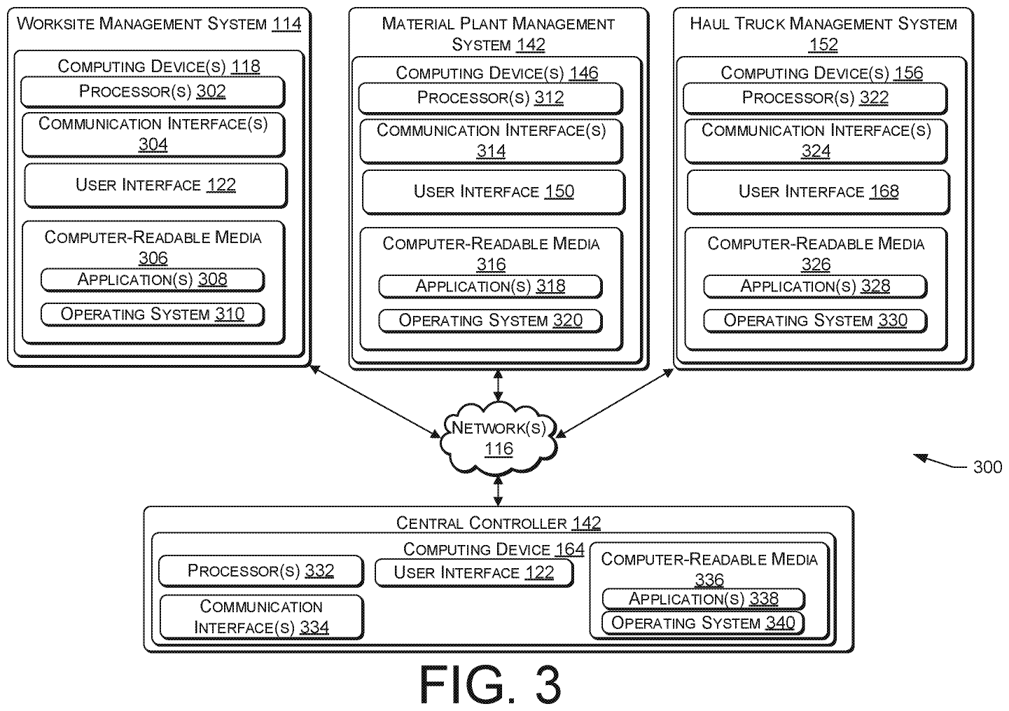

The worksite management system 114 may also receive input from user(s) and/or data indicating an amount of material(s) that have been used at the worksite 102. In some examples, the worksite management system 114 may include one or more computing devices 118 that perform the various operations of the worksite management system 114. Furthermore, in some examples, the customer may have an electronic device 120 including a user interface (UI) 122 that allows the customer to interact (e.g., provide input and/or receive output) with the worksite management system 114 (and/or a central controller 142 described further herein). The worksite management system 114 will be described further herein with respect to FIGS. 2 and 3.

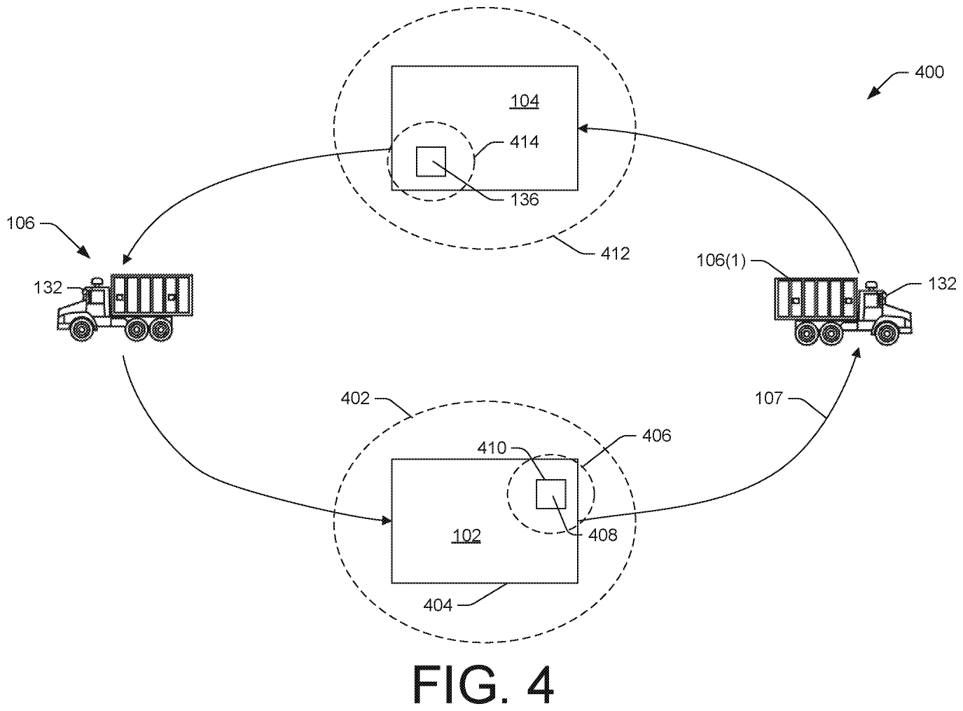

The worksite system 100 may further include a material plant management system 124 associated with the material plant 104. The material plant management system 124 may be provided to and implemented by the supplier. The material plant management system 124 may monitor various activities in the material plant 104. For example, the material plant management system 124 may determine that a haul truck 106(1) has entered the material plant 104. In some examples, the material plant 104 may include a gate 126 having a radio frequency identification (RFID) reader 128 that identifies an RFID tag 130 on the haul truck 106(1). Additionally, and/or alternatively, the material plant management system 124 may receive location data generated by one or more sensors 132 on the haul truck 106(1) and the material plant management system 124 may compare such location data with one or more geofences to determine whether haul truck 106(1) has entered the material plant 104. The use of geofences in determining component location and/activity is described further herein below with respect to FIG. 4.

Other methods and systems of identifying entry of the haul trucks 106 may be included in the material plant 104 and the material plant management system 124. The material plant 104 may also include a check-in station 134. The check-in station 134 may include an attendee that checks haul trucks 106 into the material plant 104 upon arrival. Additionally, and/or alternatively, the check-in station 134 may be automated via a similar RFID system described above. In some examples, upon checking in, check-in information may be sent to the material plant management system 124. The check-in information may include information such as a specific truck identifier, a haul truck operator, a weight of the haul truck upon entry, a check-in time, etc. In some examples, the gate 126 may be omitted and the check-in station 134 may represent an entry point into the material plant 104.

In some examples, once the haul truck 106(1) has checked in, a work order form may be generated that specifies a type and amount of material to be loaded onto the haul truck 106(1). The work order form may be printed and/or sent to one or more load stations 136 and/or a loader at the load station 136. In some examples, the work order form may be sent to the material plant management system 124 in addition to or instead of the station 136 which may in turn distribute the work order form to other components (e.g., loader, load station 136, scale house, etc.) of the material plant 104. In some examples, the load station 136 may include one or more sensors 138 configured to determine the presence and/or location of one or more haul trucks 106 (e.g., the haul truck 106(1) shown in FIG. 1), a time at which the haul truck 106(1) arrived at the load station 136, a time at which the haul truck 106(1) departed the load station 136, an amount (e.g., a weight) of material loaded into the haul truck 106(1), and or other information associated with the haul truck 106(1). The load station 136 may include one or more loaders that are configured to send data indicating a time at which the haul trucks 106 are loaded with material, a type of material loaded on the haul trucks 106, an amount of material loaded on the haul trucks 106, etc. In some examples, the sensor 138 may comprise a scale or other mass sensor configured to determine the weight of the haul truck 106(1) upon entering the load station 136, the weight of the haul truck 106(1) prior to being loaded with material, the weight of the haul truck 106(1) after material has been loaded into the haul truck 106(1), and/or a change in weight of the haul truck 106(1). Such information may be used to generate scale ticket data. The scale ticket data may be sent to a central controller 142 (described further herein below) and/or the various management systems described herein. The scale ticket data (and/or other information described herein) may enable the central controller 142 to provide the various management systems with information and data to coordinate various events and tasks associated with the worksite system 100. By doing so, the worksite system 100 may be connected and may provide a steady flow of material throughout the worksite system 100 and may reduce unexpected delays.

The material plant 104 may also include one or more scale houses, operator stations, or other stations for use by material plant 104 personnel. In some examples, the haul truck 106(1), once loaded, may proceed to the scale house 140 where the haul truck 106(1) may be weighed and a scale ticket may be generated (e.g., a physical scale ticket may be printed and/or electronic scale ticket data may be generated). In some examples, when the scale ticket is printed, scale ticket data may be sent to the material plant management system 124 and/or a central controller 142, as will be described further herein. The scale ticket and scale ticket data may include several attributes of given equipment. For example, the scale ticket for the haul truck 106(1) may, without limitation include the truck identification of the haul truck 106(1), a destination of the haul truck 106(1), a weight of the haul truck 106(1), and a check-out time of the haul truck 106(1). In some examples, the destination may correspond with the worksite 102 associated with the customer.

The scale ticket data may further include a type of material loaded on the haul truck 106(1), an identity of an operator (e.g., a driver) of the haul truck 106(1), a haul company associated with the haul truck 106(1), the customer associated with the destination, the worksite 102 associated with the destination, etc. Similar to the worksite management system 114, the material plant management system 124 may include a network 116, via which, data and other information may be sent or received. In some examples, the network 116 may include a same or similar network type as the network 116 of the worksite management system 114. The material plant management system 124 may also include one or more computing devices 146 that perform at least a portion of the operations of the material plant management system 124. In some examples, the supplier may have an electronic device 148 that provides a user interface (UI) 150 allowing the supplier to interact (e.g., provide input and/or receive output) with the material plant management system 124 and/or the central controller 142.

Furthermore, the worksite system 100 may also include a haul truck management system 152 associated with the haul trucks 106. The haul truck management system 152 may be provided to a haul company that manages the haul trucks 106. In some examples, the haul trucks 106 may send, via a network 116, location data generated by the one or more sensors 132 to the haul truck management system 152. Thus, the haul truck management system 152 may track the location of the haul trucks 106. Similar to the worksite management system 114, the haul truck management system may include one or more computing devices 156 that perform at least a portion of the operations of the haul truck management system 152. In some examples, the haul truck management system 152 may include an electronic device 158 having a user interface 160 allowing a user to interact (e.g., provide input/receive output) with the haul truck management system 152.

In some examples, the worksite management system 114, the material plant management system 124, and the haul truck management system 152 may be in communication with a central controller 142. The central controller 142 may receive, via a network 116, data and other information from the various management systems. The central controller 142 may include one or more computing devices 164 that perform at least a portion of the operations of the central controller 142. The central controller 142 may further include an electronic device 166 having a user interface 168 that may display information and/or data and may allow various management systems to interact (e.g., provide input/receive output) with the central controller 142. In some examples, the central controller 142 may receive data from the various management systems and redistribute such data. For example, the central controller 142 may receive scale ticket data from the material plant management system 124 and the central controller 142 may provide the scale ticket data to the worksite management system 114 and/or the haul truck management system 152. By providing the scale ticket data to other management systems, the central controller 142 provides insight and accountability into the worksite system 100.

For example, by providing the scale ticket data (and other information described herein) to the worksite management system 114, the central controller 142 may provide the worksite management system 114 with information to: determine an amount of material that is in transit to the worksite 102, determine a quantity haul trucks 106 are at the worksite 102 at which times, determine a quantity of haul truck 106 loads that are delivered per project, per day, and/or per hour, verify payments via load information included in the scale ticket data, identify material theft (e.g., identify material that should be delivered but is not delivered), identify material unavailability from a supplier (such as a supplier associated with material plant 104), identify haul truck 106 delays, identify incorrect delivery of material (e.g., wrong material and/or at wrong site), identify excess material that may be recycled, among various other determinations and operations.

Furthermore, by providing the scale ticket data (and other information described herein) to the material plant management system 124, the central controller 142 may provide the material plant management system 124 with information to: determine an amount of material delivered at various time intervals (e.g., a rate of material delivered), determine an average sale amount per hour, per day, per material type etc., use the sales amount and rate as input for material production rate management, determine completed loads and compare with target loads (e.g., how many loads are completed, how many target loads for specified time interval), determine an amount of material left and compare with stock availability, among various other determinations and operations.

Still further, by providing the scale ticket data (and other information described herein) to the haul truck management system 152, the central controller 142 may provide the haul truck management system 152 with information to: determine a quantity (and identity) of haul trucks 106 deployed for specific jobsite and/or projects, determine productivity of the haul trucks 106, generate a haul truck productivity report (including, but not limited to tasks associated with a cycle of the haul truck (i.e., receive material, haul to destination, deposit material, return to material plant for additional material, etc.), hours of operation, loads per haul truck, etc.), determine pay structure from the productivity report for specific haul truck operators, determine haul truck delays and customer and/or supplier concerns related to trick delays at worksites and/or material plants, determine efficient truck dispatchment to multiple jobs, augment an electronic log integrated in the haul trucks 106 to identify truck operator working hours, determine location and past location of haul trucks 106, receive truck spotting and tracking data, among various other determinations and operations.

Furthermore, the central controller 142 may process the data in order to extract information and to provide the extracted information to the various management systems. Following the example above, the central controller 142 may receive scale ticket data from the material plant management system 124. From such data the central controller 142 may determine an estimated time of arrival for the haul truck 106(1) to reach the destination of the worksite 102. The central controller 142 may then send the estimated time of arrival to one or more of the management systems. Thus, the central controller 142 may provide an interconnected system that connects various unrelated management systems. Such features will be described further herein below.

FIG. 2 depicts an example framework 200 for connecting various management systems in accordance with the present disclosure. While FIG. 2 depicts the central controller 142 as being in communication with the worksite management system 114, the material plant management system 124, and the haul truck management system 152, the central controller 142 may be in communication with additional or fewer management systems. In some examples, the various components of the framework 200 may send and receive data via a network 116. The central controller 142 may receive worksite data 202 from the worksite management system 114. Additionally, and/or alternatively, the central controller 142 may receive worksite data 202 directly from the various components of the worksite 102. The worksite data 202 may include progress of various tasks or jobs associated with a project. In some examples, the project may include an overarching job to be completed that includes various tasks that must be completed in order to finish the project. For example, in a paving project (e.g., paving of a parking lot), multiple tasks must be completed in order to finish the paving project. Such tasks may include excavating, scaping, placement, compacting, etc. Thus, the worksite data may include progress of such tasks (e.g., compacting task associated with a paving project), location and/or status (e.g., idle, moving, excavating, paving, etc.) of machinery on the worksite 102, an amount and/or type of materials at the worksite 114, etc. For example, the worksite management system 114 may send worksite data indicating a time at which one or more haul trucks 106 entered the worksite 102, a time at which the one or more haul trucks 106 deposited material at the worksite 102, an amount of time the one or more haul trucks 106 spent at the worksite 102, a time at which the one or more haul trucks 106 left the worksite 102, etc. In some examples, the central controller 142 may be configured to send at least a portion of the worksite data 202 to the material plant management system 124 and/or the haul truck management system 152. Additionally, and/or alternatively, the central controller 142 may process at least a portion of the worksite data 202 and may provide corresponding resultant data to the material plant management system 124 and/or the haul truck management system 152.

The framework 200 further shows the central controller 142 being operably connected to the material plant management system 124. The central controller may receive material plant data 204 from the material plant management system 124. Additionally, and/or alternatively, the central controller 142 may receive the material plant data 204 directly from the various components of the material plant 104. The material plant data 204 may include location information and/or status information associated with haul trucks 106 within the material plant, scale ticket data, a time at which one or more haul trucks 106 entered the material plant 104, a time at which the one or more haul trucks 106 checked into the material plant 104, a time at which the one or more haul trucks 106 were loaded with material, a time at which the one or more haul trucks 106 checked out of the material plant, etc.

In some examples, the scale ticket data may include an identifier of a haul truck 106(1), a quantity (e.g., weight, volume, etc.) of material loaded on the haul truck 106(1), a destination (e.g., the worksite 102) of the haul truck 106(1), and a check-out time indicating a time at which the scale ticket data was generated. The haul truck 106(1) identifier may include a vehicle identification number (VIN), license plate, company specific truck number (e.g., truck #45), or any other identifier assigned by the customer, supplier, and/or haul company. In some examples, the check-out time may indicate a time at which the haul truck 106(1) left the material plant 104. Additionally, and/or alternatively, the scale ticket data may include a type of material loaded on the haul truck 106(1), an identity of an operator of the haul truck 106(1), a haul company associated with the haul truck 106(1), a customer associated with the destination, or a worksite 102 associated with the destination. As mentioned previously, the material plant management system 124 may send the scale ticket data to the central controller 142.

The framework 200 further shows the central controller 142 being operably connected to the haul truck management system 152. The central controller 142 may receive haul truck data from the haul truck management system 152. Additionally, and/or alternatively, the central controller 142 may receive haul truck data from the haul trucks 106 directly. The haul truck data may include location data for each haul truck in the fleet of haul trucks. In some examples, the location data may identify a path 107 taken by a given haul truck 106(1) as the haul truck 106(1) travels between the material plant 104, the worksite 102, and/or other locations. The location data may include transit information including an amount of time needed for the haul truck 106(1) to traverse the path 107. The location data may further include a current location of the haul truck 106. In some examples, the haul truck 106 may report sua sponte a current location to the haul management system 152 on predetermined intervals.

As mentioned previously, the central controller 142 may be configured to distribute controller data 208 and/or processing results with the management systems shown in FIG. 2. The controller data 208 sent by the central controller 142 may include unprocessed data (e.g., the worksite data 202, material plant data 204, and/or haul truck data 206 received from the management systems) and/or may include processed data. Thus, the central controller 142 may reduce any redundancies when sharing data 206 with multiple systems. For example, rather than the worksite management system 114 sending worksite data 202 to each of the other management systems (in this example the material plant management system 124 and the haul truck management system 152), the worksite management system 114 may only need to transmit the worksite data 202 to the central controller 142. The central controller is configured to process the data and/or determine to which management systems the data (processed and/or unprocessed) should be sent. In some examples, users of the various management systems may specify which other management systems receive specific types of data. Furthermore, users of the various management systems may specify information that the users may want to receive from the central controller 142 based on the data that the central controller 142 receives from other management systems. This may conserve battery life of the electronic devices associated with the respective management system and/or may conserve the resources needed for data processing and data dispatch by the respective management systems. Thus, the central controller 142 may provide connection and/or communication between various entities and/or components of a worksite system 100 that may not be connected otherwise due, in part, to the management system being associated with different entities in some examples.

FIG. 3 illustrates an example architecture of a system 300 that connects the management systems via the central controller 142. As mentioned previously, the worksite management system 114 includes one or more computing devices 118. Such a computing device 118 may include one or more processors 302, communication interfaces 304, and a user interface 122 that may be generated by the computing device 118. In some examples, the user interface 122 may provide an input/output interface presented to a user via an electronic device 120. For example, the user interface 122 may include a display, various UI controls (e.g., buttons, mouse, keyboard, touch screen, etc.), audio speakers, and so forth. The processors 302, as well as the other processors described herein, may be a single processing unit or a number of processing units and may include single or multiple computing units or multiple processing cores. The processors 302 may be configured to fetch and/or execute computer-readable instructions stored in computer-readable media 306, such as one or more software modules or components.

The computer-readable media 306, as well as the other computer-readable media described herein, may include volatile and nonvolatile memory and/or removable and non-removable media implemented in any type of technology for storage of information, such as computer-readable instructions, data structures, program modules, or other data. Such computer-readable media 306 includes, but is not limited to, RAM, ROM, EEPROM, flash memory or other memory technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that may be used to store the desired information and that may be accessed by a computing device or other processor. Depending on the configuration of the worksite management system 114 (and the other management systems described herein) the computer-readable media 306 may be a type of computer-readable storage media and may be a non-transitory storage media. The computer-readable media 306 may include functional components that are executable by the processors 302. Such functional components may include one or more applications 308 and an operating system 310. The applications 308 may include a browser application, a mobile application, an online application, or the like, able to communicate with the central controller 142 via the network(s) 116.

The computing device 118 may further include communication interface(s) 304. The communication interface(s) 304, as well as the other communication interfaces described herein, may include one or more interfaces and hardware components for enabling communication with various other devices, such as the electronic devices 120, 148, 158, and 166, over the network(s) 116. For example, communication interface(s) 304 may facilitate communication through one or more of the Internet, cable networks, cellular networks, wireless networks (e.g., Wi-Fi, cellular, near-field) and wired networks. Various different approaches to examples described herein may be implemented in various systems. For examples, the network(s) 116 may include any appropriate network, including, intranet, Internet, a cellular network, a LAN, WAN, VPN, or any other network or combination thereof. Components used for such a system may depend at least in part upon the type of network and/or system. Protocols and components for communicating via such networks are well known and thus, will not be discussed in detail.

In some examples, the material plant management system 124 may include similar components as those described above with respect to the worksite management system 114. For example, the material plant management system 124 may also include one or more computing devices 146, one or more processors 312, communication interface(s) 314, a user interface 150 associated with the material plant management system 124, computer-readable media 316 including one or more application(s) 318 and an operating system 320. Furthermore, as shown in FIG. 3, the haul truck management system 152 may include similar components as those described above with respect to the worksite management system 114 and the material plant management system 124. As shown in FIG. 3, the central controller 142 may further include components similar to those described above with respect to the management systems. While the components of the central controller 142 may be similar to the components of the various management systems, the function of data processing is unique to the central controller 142. The central controller 142 may be configured as a controller over the various management systems described herein.

FIG. 4 is a diagram illustrating an example system 400 for tracking various components associated with the worksite system 100 in accordance with the present disclosure. As mentioned previously, the haul trucks 106 may send location data, generated by the sensors 132, to the haul truck management system 152 and/or the central controller 142. Thus, the central controller 142 and/or the haul truck management system 152 may track a location of the haul trucks as they traverse the path 107 between various locations associated with the worksite system 100. In some examples, the central controller 142 may generate a first geofence 402 around a worksite or a jobsite such as the worksite 102 of the worksite system 100 described in FIG. 1. Additionally, and/or alternatively, the central controller 142 may instruct the worksite management system 114 to generate the first geofence 402. Additionally, and/or alternatively, the central controller 142 may receive, from the worksite management system 114 (or other management systems), data (e.g., coordinates, GPS data, and/or other location data) representing the geofences described herein. While FIG. 4 depicts the first geofence 402 as being located outside of and surrounding the worksite 102, in some examples, the central controller 142 may generate the first geofence 402 such that the first geofence 402 substantially overlays a perimeter 404 of the worksite 102. From at least the location data, the central controller 142 may determine when a haul truck 106(1) has entered the first geofence 402, thereby determining when the haul truck 106(1) has entered the worksite 102. Additionally, and/or alternatively, the worksite management system 114 may receive the location data from the haul truck 106(1) and may send an indication to the central controller 142, the indication identifying the one or more geofences that the haul truck 106(1) has entered. In some examples, two or more geofences may overlap, at least partially. The indication may include information indicating that the haul truck 106(1) is within multiple geofences or a single geofence in the case of overlapping geofences. In some examples, the central controller 142 may determine, based on an indication that the haul truck 106(1) has arrived at the worksite 102, a travel time for the haul truck 106(1) to traverse the path 107 between the material plant 104 and the worksite 102.

The central controller 142 may also generate (or receive data representing) a second geofence 406 around a deposit location 408 designating an area of the worksite 102 in which the haul trucks 106 are to deposit the material. In some examples, the second geofence 406 may be at least partially inside the first geofence 402. Similar to the first geofence 402, the second geofence 406 may substantially overlay a perimeter 410 of the deposit location 408. In some examples, the central controller 142 may determine, from the location data, a distance between the haul trucks 106 and the first geofence 402 and/or the second geofence 406. Furthermore, upon determining that the haul truck 106(1) has entered the first geofence 402, the central controller 142 may provide a notification to at least one of the worksite management system 114, the haul truck management system 152, or the material plant management system 124 indicating that the haul truck 106(1) has reached the destination of the worksite 102. The notification may include a time at which the haul truck 106(1) entered the first geofence. Additionally, and/or alternatively, the central controller 142 may provide a notification to one or more of the management systems when the haul truck 106(1) leaves the various geofences associated with the system 400. The central controller 142 may generate any number of geofences at various locations within the worksite 102. Furthermore, in some examples, the worksite management system 114 may be configured to send information to the central controller 142 indicating when one or more haul trucks 106 enter and/or exit the geofences described in FIG. 4. Such information may include a time of day at which the haul trucks enter and/or exit the first geofence 402 an/or the second geofence 406.

The central controller 142 may further monitor an amount of time that the haul truck 106(1) spends within each geofence of the system 400. For example, the central controller 142 may determine, from the location data, that the haul truck 106(1) has entered the second geofence 406 and may further determine from the location data an amount of time that the haul truck 106(1) spends within the second geofence 406.

In some examples, when the central controller 142 determines that the haul truck 106(1) has spent a threshold amount of time within the second geofence 406, the central controller 142 may assume that the haul truck 106(1) has deposited the material at the deposit location 408. The central controller may dynamically determine the threshold time based on a time at which the haul truck 106(1) enters the first geofence 402 as the haul truck 106(1) enters the worksite 102. In some examples, the central controller 142 identifies the quantity of material, based at least in part on the scale ticket data, that has been previously loaded on the truck. Further, a total amount of time needed to unload the identified quantity of material is configured as a threshold time. In some examples, a user associated with the worksite management system 114 may specify the threshold time via the electronic device 120. Additionally, and/or alternatively, the central controller 142 may determine the threshold time based on an average amount of time that the haul trucks 106 spend within the second geofence 406. The average amount of time may be determined based on historical location data of the haul trucks 106. Furthermore, the central controller 142 may determine that the haul truck 106(1) has entered the first geofence 402 but has not yet entered the second geofence 406.

In some examples, the central controller 142 may determine that the haul truck 106(1) entered the first geofence 402 but has not deposited the material within the second geofence 406. For example, the central controller 142 may determine an amount of time that the haul truck 106(1) has been within the first geofence 402 without entering the second geofence 406. If the amount of time is greater than a threshold amount of time (i.e., either set by the central controller 142 or specified by a user), the central controller 142 may notify one or more of the management systems. The central controller 142 may provide a notification to at least one of the worksite management system 114, the material plant management system 124, or the haul truck management system 152 that the haul truck 106(1) has deposited the material based in part on the haul truck being within the second geofence 406 for at least the threshold amount of time.

Such a notification may include an indication that the haul truck 106(1) is returning to the material plant 104 to haul more material from the material plant 104. In some examples, the location data may include historical location data from the haul trucks 106 that have previously traversed the path 107 between the material plant 104 and the worksite 102. From such historical location data, the central controller 142 may estimate a travel time and/or an estimated time of arrival for the haul truck 106(1) to travel between the material plant 104 and the worksite 102 and vis versa. In some examples, the central controller 142 may retrieve traffic data from a traffic database in order to accurately estimate the travel time.

Similar to the first geofence 402 and the second geofence 406, the central controller 142 may generate (and/or receive data representing) a third geofence 412 around the material plant 104 and/or generate a fourth geofence 414 around a loading station 136. In some examples, the material plant management system 124 may generate the third geofence 412 and the fourth geofence 414. In some examples, the material plant management system 124 may be configured to send information to the central controller 142 indicating when one or more haul trucks 106 enter and/or exit the third geofence 412 and the fourth geofence 414.

Such information may include a time of day that the haul trucks 106 enter and/or exit the third geofence 412 and the fourth geofence 414. The central controller 142 may provide a notification to at least one of the worksite management system 114, the material plant system 124, or the haul truck management system 152 indicating that the haul truck 106(1) has entered the third geofence 412. The central controller 142 may further provide a notification to one or more of the management systems indicating that the haul truck 106(1) has been loaded with material based on the haul truck 106(1) being within the fourth geofence 414 for a threshold amount of time. Additionally, and/or alternatively, as described above, the central controller 142 may also receive an indication from a loader that the haul truck 106(1) has been loaded with the material, the indication including a time at which the haul truck 106(1) was loaded with the material. In some examples, the central controller 142 may determine a time difference between the time of day that the haul truck 106(1) entered the third geofence 412 (i.e., a time that the haul truck entered the material plant 104 and/or checked into the material plant 104) and a time that the haul truck 106(1) leaves the third geofence (i.e., checks out of the material plant 104) or a time that the haul truck enters the fourth geofence 414 (i.e., is loaded with material at loading station 136). If a value of the time difference is greater than a threshold time difference value, the central controller 142 may provide information to the one or more management systems indicating that the time difference is greater than a threshold time difference. The threshold time difference may be determined dynamically based on historical time differences (i.e., the threshold time difference may represent an average time difference). Additionally, and/or alternatively, the threshold time difference may be specified by a user associated with the material plant management syst 124 via the electronic device 148. In some examples, the central controller 142 may receive input, via the worksite management system 114, from an operator of the haul truck 106(1), the input may include location information and/or information indicating that the haul truck 106(1) has deposited material at the worksite 102 and/or been loaded with material at the material plant 104.

Furthermore, the central controller 142 may track the location of the haul trucks 106 as they travel a path 107 between the worksite 102 and the material plant 104. As will be described further herein, the central controller 142 may determine an estimated time of arrival for the haul trucks 106 to reach the worksite 102 after leaving the material plant 104 and/or an estimated time of arrival for the haul trucks 106 to return to the material plant 104 after they have deposited material at the worksite 102. The central controller may provide such estimated times of arrival to one or more of the management systems. In some examples, the central controller 142 may determine, from the location data, a current location of the haul truck 106(1) and may determine from the current location that the haul truck 106(1) will arrive at the destination (e.g., the worksite or the material plant) after a specified time frame, within the specified time frame, or early.

For example, the central controller 142 access one or more online maps and/or traffic databases and may calculate a travel time for the haul truck 106(1) based on the current location of the haul truck 106(1). The central controller 142 may provide a notification to one or more of the management systems indicating that the haul truck 106(1) will arrive after the estimated time of arrival, within the specified time frame, or early. Thus, the central controller 142 may notify the various entities of any unexpected changes in an arrival of the haul trucks 106 that may occur in near real-time. Furthermore, the central controller 142 may use historical location data from the haul trucks 106 to determine an average travel time between various destinations of the haul trucks 106. In some examples, the central controller 142 may determine the average travel time based in part on the time of day included in the historical location data, thereby accounting for traffic patterns throughout a day. As described previously, the central controller 142 may provide such average travel times to various management systems based on data received from one or more other management systems.

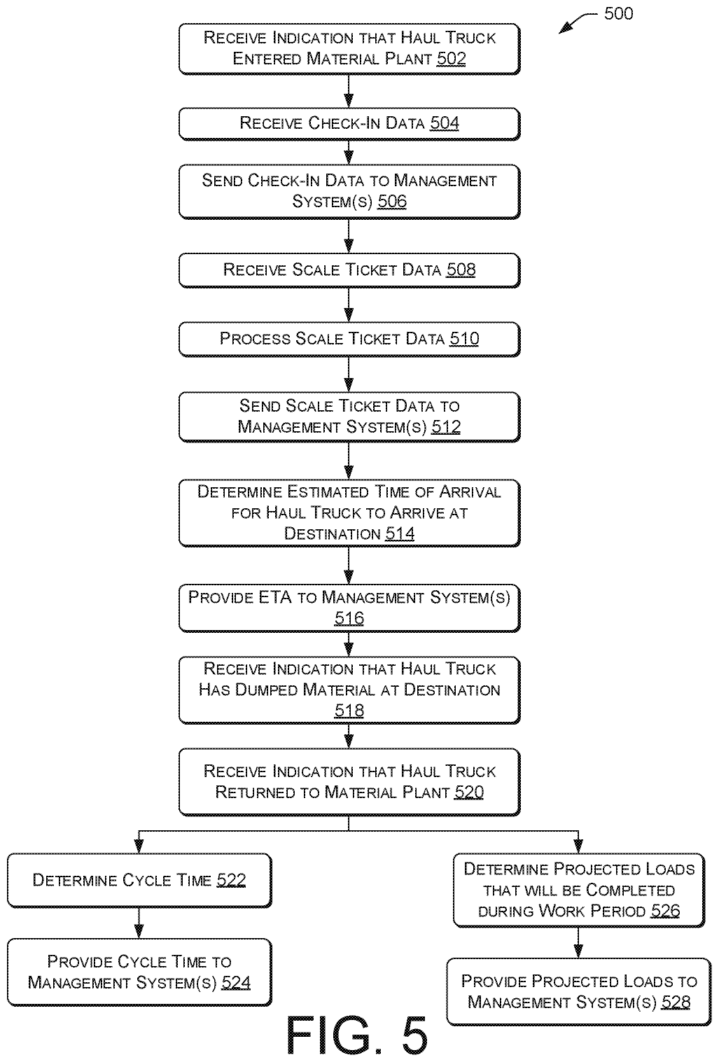

FIG. 5 depicts an example method 500 of connecting various management systems in accordance with the present disclosure. The example method 500 is illustrated as a collection of steps in a logical flow diagram, which represents operations that may be implemented in hardware, software, or a combination thereof. In the context of software, the steps represent computer-executable instructions stored in memory. Such computer-executable instructions may include routines, programs, objects, components, data structures, and the like that perform particular functions or implement particular abstract data types. The order in which the operations are described is not intended to be construed as a limitation, and any number of the described steps may be combined in any order and/or in parallel to implement the process. For discussion purposes, and unless otherwise specified, the method 500 is described with respect to the management systems described in FIGS. 1-4 and the central controller 142.

With reference to FIG. 5, at 502, the central controller 142 may receive an indication that a haul truck 106(1) has entered a material plant 104. In some examples, the central controller 142 may receive the indication from the material plant management system 124. As described previously, the central controller 142 may receive such an indication based on one or more geofences that are located around the material plant 104 or from a gate 126 of the material plant 104. Furthermore, the central controller 142 may receive the indication that the haul truck 106(1) has entered the material plant 104 from an operator of the haul truck 106(1) via an electronic device associated with the haul truck 106(1).

At 504, the central controller 142 may receive check-in data from a material plant management system 124. The check-in data may be generated at the check-in station 134 and may be sent to the material plant management system 124, which may, in turn, send the check-in data to the central controller 142. The check-in data may include a haul truck identifier such as a vehicle identification number (VIN), license number, truck number, etc. The check-in data may further include a check-in time at which the haul truck 106(1) checked into the material plant 104, a haul company associated with the haul truck 106(1), a work order assigned to the haul truck 106(1), etc. The check-in data may enable the material plant management system 124 to track a quantity of haul trucks 106 that are present at the material plant 104 at any given time.

At 506, the central controller 142 may send the check-in data to a haul truck management system 152 and/or a worksite management system 114. By sending the check-in data to the haul truck management system 152, the haul truck management system 152 may determine how many haul trucks 106 are at the material plant 104 at any given time. As will be described further herein below, by providing the check-in data to various management systems, the various management systems may track the progress of haul trucks 106 as they enter the material plant 104, are loaded with material, and leave the material plant 104. In some examples, the check-in data may be used to determine an average time that the haul trucks 106 spend at the material plant 104.

At 508, the central controller 142 may receive scale ticket data. The scale ticket data may be generated at a scale house 140 and/or the load station 136 of the material plant 104. In some examples, the scale ticket data may be sent to the material plant management system 124 which, in turn, may send the scale ticket data to the central controller 142. Additionally, and/or alternatively, the scale house 140 (or other component(s) of the material plant 104) may send the scale ticket data directly to the central controller 142.

The scale ticket data may include information indicating an identifier of a haul truck 106(1), a weight of material loaded on the haul truck 106(1), a destination of the haul truck 106(1), and/or a check-out time indicating a time at which the haul truck 106(1) leaves (or is weighed) the material plant 104 with the material. The scale ticket data may further include information indicating a type of material loaded on the haul truck 106(1), an identity of an operator (e.g., driver) of the haul truck 106(1), a haul company associated with the haul truck 106(1), a customer associated with the destination (such as the worksite 102, for example), additional destinations for the haul truck 106(1), a path 107 that the haul truck 106(1) may take between the material plant 104 and the destination, a worksite 102 associated with the destination, etc. The scale ticket data may include any information associated with the worksite system 100. As mentioned previously, the central controller 142 may determine an amount of time that the haul truck 106(1) spends at the material plant 104 by determining a time difference between the check-in time and the check-out time. In some examples, the central controller 142 may track the time difference for multiple haul trucks to determine an average time that the haul trucks 106 are spending at the material plant.

At 510, the central controller 142 may process the scale ticket to make various determinations and/or to determine equipment performance and/or status. For example, from the scale ticket data, the central controller 142 may determine a quantity (e.g., tonnage) of material that is being delivered and/or a rate of material being delivered. Furthermore, the central controller 142 may determine an average quantity of material sold per hour, per day, and/or per material type. The central controller 142 may further determine, from the scale ticket data, a number of loads that are completed and may compare the completed loads to a target number of loads to be completed in a work period (e.g., a work day, a week, a month, during a project, etc.). Furthermore, from the scale ticket data, the central controller 142 may determine an amount of material that is remaining at the material plant 104. The central controller 142 may also compare the remaining material at the material plant 104 with a stock availability of material. Furthermore, from the scale ticket data, the central controller 142 may determine and track where haul trucks 106 are being dispatched, a quantity and location of haul trucks 106 that are in transit to a destination, a quantity of material that is in transit to one or more destinations. Still further, the central controller 142 may verify payment for material based on the scale ticket data and work orders. For example, the central controller 142 may determine whether the quantity of material dispatched to a customer corresponds with the quantity of material for which payment was received.

At 512, the central controller 142 may provide raw scale ticket data and/or the processed scale ticket data to the various management systems of the worksite system 100. For example, the central controller 142 may send the scale ticket data to one or more of the worksite management system 114, the haul truck management system 152, and/or any other management system(s) that may be included in the worksite system 100. In some examples, the central controller 142 may be configured to send the raw data and the processed data in order to provide verification of the data and allow an end user to have a record of the raw, unaltered data, thereby increasing the security and integrity of the scale ticket data. Furthermore, if the central controller 142 receives the scale ticket data directly from the scale house 140, the load station 136, or other component(s) of the material plant 104, the central controller 142 may provide the scale ticket data to the material plant management system 124.

At 514, the central controller 142 may determine an estimated time of arrival (ETA) for one or more haul trucks 106 to reach a destination. In some examples, the destination may be identified in the scale ticket data. For example, the destination may correspond with a worksite 102 associated with a customer that purchased the material from the supplier associated with the material plant 104. Furthermore, the destination may include multiple destinations and the central controller 142 may determine ETA's for each destination. The central controller 142 may determine the ETA for a haul truck 106(1) that is identified in the scale ticket data. To determine the first ETA, the central controller 142 may retrieve map and/or traffic data from one or more databases that provide such data (e.g., various online databases providing such information).

For example, the central controller 142 may identify a path 107 that the haul truck 106(1) may take to reach the destination and may estimate the ETA for the haul truck 106(1) based on the identified path. In some examples, the central controller 142 may identify multiple paths that the haul truck 106(1) may take to reach the destination. The central controller 142 may provide multiple ETA's for the multiple paths and may provide the multiple ETA's to the management systems. Additionally, and/or alternatively, the central controller 142 may select the path having the shortest travel time and/or the shortest distance and may determine the ETA based on the selected path. The ETA may be determined from a travel time that is calculated by dividing a distance between destinations by a rate of travel that may be determined from public data (such as speed limits), resulting in an amount of time that the haul truck 106(1) may take to reach the destination.

In some examples, the central controller 142 may provide the ETA as a notification for an electronic device associated with the respective management system(s) to which the notification is sent. Furthermore, the central controller 142 may determine the ETA based on historical location data received from one or more haul trucks 106 that have previously traveled the path between the material plant 104 and the worksite 102. The historical location data may include data representing travel time and time of day that the one or more haul trucks 106 travelled the path 107. In some examples, the central controller 142 may determine an average travel time based on the historical location data.

At 508, the central controller 142 may receive a predetermined arrival time frame (referred to herein as “the predetermined time frame”) from one or more management system(s). The predetermined time frame may represent a time frame, during which, a customer may expect the haul truck 106(1) to arrive at the worksite 102. In some examples, the customer may specify, via the worksite management system 114, the predetermined time frame that the customer expects to receive a load of material from the haul truck 106(1). In some examples, the customer may specify the predetermined time frame during which the customer expects the haul truck 106(1) to arrive at the worksite 102. For example, the customer may specify a time frame (e.g., a time window or time range having a start time and an end time) on a particular day. The predetermined time frame may be sent, via the worksite management system 114 (e.g., via the network 116), to the central controller 142.

In some examples, the ETA may be a first ETA and the central controller 142 may determine a second estimated time of arrival (ETA) for the haul truck 106(1) to return to the material plant 104. The central controller 142 may determine the second ETA based on an average time that the haul trucks 106 spend at the worksite 102. The average time may be determined from historical location data received from the haul trucks 106. Additionally, and/or alternatively, the worksite management system 114 may provide the central controller 142 with the average time. In some examples, the central controller 142 may determine the second ETA once the haul truck has left the worksite 102. The central controller 142 may implement geofences, as described above, to determine when the haul truck 106(1) has left the worksite. Similar to the first ETA, the central controller 142 may retrieve map and/or traffic data from one or more databases that provide such data. The central controller 142 may use such data to determine the second ETA.

In some examples, the central controller 142 may determine the second ETA after the haul truck 106(1) has deposited material at the worksite 102. The central controller 142 may determine, from location data received from the haul truck 106(1), that the haul truck 106(1) has deposited material at the worksite and/or the central controller 142 may receive an indication from the worksite management system 114 that the haul truck 106(1) has deposited the material. For example, as described above with respect to FIG. 4, the central controller 142 may determine that the haul truck 106(1) has been within a geofence (e.g., geofence 406) for a threshold amount of time, the geofence corresponding with a deposit location 408. Additionally, and/or alternatively, the central controller 142 may receive an indication that the haul truck 106(1) has deposited the material at the worksite 102. Such an indication may be received from a supervisor of the worksite 102 via an electronic device 120 and/or may be received from an operator of the haul truck 106(1) via an electronic device 158 that may be present on the haul truck 106(1).

At 516, the central controller 142 may provide the first ETA and/or the second ETA to one or more management systems. For example, the central controller 142 may provide information representing the ETA to the worksite management system 114. The information may further include an indication of whether the ETA is before, during, or after a predetermined time frame (e.g., time range, time window). The predetermined time frame may be specified by the customer associated with the worksite 102. For example, a customer may specify a requested delivery time frame between 1:00 PM and 1:30 PM. The central controller 142 may compare the ETA with the predetermined time frame and determine whether the haul truck 106(1) will arrive before, during, or after the predetermined time frame. Additionally, and/or alternatively, the central controller 142 may provide the ETA to the material plant management system 124 and/or the haul truck management system 152. Providing the first ETA to the various management systems not only gives a customer associated with a purchase of the material an updated status as to the arrival of the haul truck 106(1) but may also provide the supplier and/or haul company insight into the scheduled arrival of the haul truck 106(1).

At 518, the central controller 142 may receive, form the worksite management system 114, an indication that the haul truck 106(1) dumped the material at the destination (e.g., the worksite 102). The central controller 142 may provide the indication to the haul truck management system 152 and/or the material plant management system 124. In some examples, the indication may include a time at which the haul truck 106(1) dumped the material at the destination. Furthermore, the indication may include an amount of material dumped at the destination. The central controller 142 may compare the amount of material with the scale ticket data in order to determine whether the amount of material dumped at the destination corresponds with the scale ticket data. If the central controller 142 determines that there is a discrepancy between the amount of material dumped at the destination and the scale ticket data, the central controller 142 may identify material theft and/or may notify one or more of the management systems of the discrepancy. As mentioned previously, once the central controller 142 determines that the haul truck 106(1) has dumped the material at the destination, the central controller 142 may determine the second ETA representing a time at which the haul truck 106(1) will return to the material plant 104.

At 520, the central controller 142 may receive, from the material plant management system 124, an indication that the haul truck 106(1) has returned to the material plant 104 after dumping the load of material at the destination. Such an indication may be received when the haul truck 106(1) enters the material plant 104 and/or when the haul truck 106(1) checks into the material plant 104, as described above. The indication may include a time at which the haul truck 106(1) arrived back at the material plant 104.

At 522, the central controller 142 may determine a cycle time based at least in part on the indication that the haul truck 106(1) arrived back at the material plant 104. The cycle time may represent an amount of time for the haul truck 106(1) to be loaded with material at the material plant 104, dump the material at the destination, and return to the material plant. The cycle time may be determined over the course of time and may therefore represent an average cycle time for multiple haul trucks. Furthermore, a cycle time may be calculated for multiple material suppliers and/or customer destinations. The cycle time may also include various time segments representing an amount of time for various tasks associated with the cycle to be completed. For example, the cycle time may include an amount of time for the haul truck 106(1) to be loaded with material at a loading station 136.

At 524, the central controller 142 may provide the cycle time to one or more of the management systems. By providing the cycle time to the various management systems, the various management systems receive insight into the cycle of the worksite system 100 and the various tasks associated therewith.

At 526, the central controller 142 may determine a projected number of loads that may be completed during a work period. The projected number of loads may represent a number of loads that may be loaded and delivered during a specified work period (e.g., work day, week, month, during a project, etc.). The central controller 142 may determine the projected number of loads based in part on the indication that the haul truck 106(1) has returned to the material plant. Additionally, and/or alternatively, the central controller 142 may determine the projected number of loads based in part on the cycle time. The central controller 142 may rely on one or more data maps, look-up tables, neural networks, algorithms, machine learning algorithms, data layers, predictive layers, and/or other components relating to the operating conditions and the operating environment of the worksite system 100 that may be stored in the memory of the central controller 142. In some examples, the central controller 142 may determine a number of haul trucks that are available and/or will be available to haul material between the material plant 104 and the destination. The central controller 142 may use the number of available haul trucks 106 to determine the number of projected loads that may be completed during the work period based at least in part on how much time is remaining in the work period. The central controller 142 may use historical data to account for down time and delays.

At 528, the central controller 142 may provide the projected number of loads to one or more of the management systems. By providing the projected number of loads to the various management systems, the various entities associated with the various management systems are able to accurately plan various tasks based on the available resources.

### INDUSTRIAL APPLICABILITY

The present disclosure describes systems and methods for connecting a supplier management system to a customer management system. The systems and methods described herein may use scale ticket data to connect the supplier management system to the customer management system. For example, such systems and methods may enable a central controller 142 to receive scale ticket data from a material plant management system 124. The central controller 142 may determine, from the scale ticket data, an estimated time of arrival for a haul truck 106 to arrive at a worksite 102 with material for a project associated with the worksite 102. The central controller 142 may also notify the various management systems when delays occur. As a result, the central controller 142 may provide, in near real-time, the status of various components of a worksite system 100, thereby allowing various entities to efficiently coordinate the operations of the components of the worksite system 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method, comprising:
receiving, with a controller and from a material plant management system in communication with the controller, check-in data for a haul truck that has checked into a material plant, the check-in data including a haul truck identifier, a check-in time representing a time at which the haul truck checked into the material plant, and a haul company associated with the haul truck;
sending, via a network, the check-in data to a haul truck management system associated with the haul company and in communication with the controller;
receiving, with the controller and from the material plant management system, scale ticket data including a quantity of material loaded on the haul truck, a destination of the haul truck, a customer associated with the destination, and a check-out time indicating a time at which the haul truck leaves the material plant with the material;
sending, via the network, the scale ticket data to the haul truck management system and a worksite management system associated with the customer and in communication with the controller;
determining, with the controller and based on the check-out time, information representing an estimated time of arrival representing a time at which the haul truck will reach the destination; and
providing, with the controller and via the network, the estimated time of arrival to the worksite management system and the haul truck management system.

2. The method according to claim 1, further comprising:
receiving, from the worksite management system, a first indication that the haul truck has entered a first geofence that substantially overlays a worksite associated with the destination, the first indication including a time at which the haul truck entered the worksite;
determining, with the controller and based on the first indication, a travel time for the haul truck to traverse a path between the material plant and the worksite; and
providing, via the network, the first indication and the travel time to the worksite management system and the haul truck management system.

3. The method according to claim 1, further comprising providing the check-out time and the quantity of material loaded on the haul truck to the worksite management system.

4. The method according to claim 1, wherein the scale ticket data further includes a type of material loaded on the haul truck, an operator, the haul company associated with the haul truck, and the haul truck identifier.

5. The method according to claim 1, wherein the estimated time of arrival is a first estimated time of arrival and the method further comprises:
receiving, from the worksite management system, a second indication that the haul truck dumped the material at a deposit location within the worksite, the second indication including a time at which the haul truck dumped the material at the deposit location;
determining, with the controller and based on the second indication, information representing a second estimated time of arrival representing a time at which the haul truck will return to the material plant; and
providing, via the network, the second estimated time of arrival to the material plant management system and the haul truck management system.

6. The method according to claim 5, further comprising:
determining, with the controller and based at least in part a time difference between the check-out time and the time at which the haul truck dumped the material at the deposit location, a projected quantity of material that will be delivered during a work period; and
providing, via the network, the projected quantity of material to the material plant management system and the worksite management system.

7. The method according to claim 1, further comprising:
receiving location data from the haul truck;
receiving, via the network, data representing a predetermined time frame, during which, the customer expects the haul truck to arrive at the destination;
determining, with the controller and based on the location data, that the haul truck will arrive later than the predetermined time frame; and
sending, via the network, a notification to the worksite management system and the haul truck management system, the notification indicating that the haul truck will arrive later than the predetermined time frame.

8. The method according to claim 1, further comprising:
receiving, with the controller, an indication that the haul truck has entered the material plant, the indication including a time of day at which the haul truck entered the material plant;
determining, with the controller, a time difference between the time of day at which the haul truck entered the material plant and the check-out time;
determining, with the controller, whether the time difference is greater than a threshold time difference; and
providing, with the controller and via the network, a notification to the material plant management system and the worksite management system based at least in part on the time difference being greater than the threshold time difference, the notification indicating that the time difference is greater than the threshold time difference.

9. A system, comprising:
one or more processors; and
non-transitory computer-readable media storing instructions that, when executed by the one or more processors, causes the one or more processors to perform operations comprising:
receiving, from a material plant management system, check-in data for a haul truck that has checked into a material plant, the check-in data including a haul truck identifier and a check-in time;
receiving, from the material plant management system, scale ticket data including a destination of the haul truck and a check-out time at which the haul truck exits the material plant with a load of material;
sending, via a network, the scale ticket data to a haul truck management system associated with the haul truck and a worksite management system associated with the destination;
determining, based on the check-out time and the destination, an estimated time of arrival representing a time at which the haul truck will reach the destination; and
providing, via the network, the estimated time of arrival to the haul truck management system and the worksite management system.

10. The system according to claim 9, wherein the estimated time of arrival is a first time of arrival and the operations further comprise:
receiving, from the worksite management system, an indication that the haul truck has dumped the load at the destination, the indication including a time at which the haul truck dumped the load;
determining, based on the indication, a second time of arrival representing a time at which the haul truck will return to the material plant; and
providing, via the network, the second time of arrival to the material plant management system and the haul truck management system.

11. The system according to claim 9, wherein the load is a first load and the operations further comprise:
receiving, from the material plant management system, an indication that the haul truck has entered the material plant after dumping the first load at the destination, the indication including a time at which the haul truck entered the material plant;
determining, based on the indication, a cycle time representing an amount of time that lapses between the check-in time and the truck entering the material plant after dumping the first load at the destination; and
providing, via the network, the cycle time to at least one of the material plant management system, the haul truck management system, or the worksite management system.

12. The system according to claim 9, the operations further comprising:
receiving first coordinates representing a first geofence substantially overlaying a perimeter of a worksite, the worksite being the destination for the haul truck;
receiving location data from the haul truck, the location data including at least a current location of the haul truck;
determining, from the location data, a time at which the haul truck entered the first geofence;
determining, based on the time at which the haul truck entered the first geofence, a traversal time for the haul truck to traverse a path between the material plant and the worksite; and
providing, via the network, the traversal time to at least one of the worksite management system or the haul truck management system.

13. The system according to claim 12, the operations further comprising:
receiving second coordinates representing a second geofence identifying an area in which the haul truck is to dump the load, wherein the second geofence is at least partially inside the first geofence;
determining, from the location data, a time at which the haul truck leaves the second geofence after dumping the load;
determining a time difference between the time at which the haul truck entered the first geofence and the time at which the haul truck leaves the second geofence; and
sending the time difference to the worksite management system.

14. The system according to claim 9, the operations further comprising:
receiving, from the worksite management system, a predetermined time frame during which a customer associated with the destination expects the haul truck to arrive at the destination; and
determining whether the estimated time of arrival is within the predetermined time frame, wherein the estimated time of arrival includes information indicating that the estimated time of arrival is within the time frame.

15. The system according to claim 9, wherein the estimated time of arrival is a first estimated time of arrival and the operations further comprise:
receiving, from the haul truck management system, an indication that the haul truck arrived at an incorrect destination, the indication including a location of the incorrect destination;
determining, based on the location, a second estimated time of arrival representing a time at which the haul truck will reach the destination.

16. The system according to claim 9, the operations further comprising:
receiving, from the worksite management system, a material purchase request;
generating a work order based on the material purchase request, the work order identifying a type of material to be purchased and an amount of material to be purchased;
sending the work order to the material plant management system;
receiving, from the material plant management system, verification that the material plant has the type of material and the amount of material to be purchased; and
sending the verification to the worksite management system; and
sending a haul request to the haul truck management system, the haul request indicating the type of material and the amount of material to be hauled between the material plant and the destination.

17. A system, comprising:
a controller;
at least one haul truck; and
a network,
wherein the controller is configured to perform operations comprising:
receiving, from a material plant management system in communication with the controller, check-in data for a haul truck that has checked into a material plant, the check-in data including a haul truck identifier, and a check-in time representing a time at which the haul truck checked into the material plant;
receiving, from the material plant management system, scale ticket data including a destination of the haul truck, a type of material loaded on the haul truck, a quantity of material loaded on the haul truck, and a check-out time indicating a time at which the haul truck exits the material plant;
sending, via the network, the haul truck identifier and the destination to a haul truck management system associated with the haul truck;
determining, with the controller and based on the check-out time, an estimated time of arrival representing a time at which the haul truck will arrive at the destination; and
providing, via the network, the estimated time of arrival, the type of material, and the quantity of material, to a worksite management system associated with the destination.

18. The system according to claim 17, the operations further comprising:
receiving, from the worksite management system, a first indication that the haul truck has dumped the material at the destination, the first indication including a time at which the haul truck dumped the material at the destination;
receiving, from the material plant management system, a second indication that the haul truck returned to the material plant for additional material, the second indication including a time at which the haul truck entered the material plant after dumping the material;
determining, with the controller, a cycle time representing an amount of time for the haul truck to be loaded with the material at the material plant, dump the material at the destination, and return to the material plant; and
providing, via the network, the cycle time to at least one of the material plant management system, the worksite management system, or the haul truck management system.

19. The system according to claim 18, the operations further comprising:
determining, based on the cycle time, a projected number of loads that will be completed in a work period; and
providing, the projected number of loads to the material plant management system, the worksite management system, and the haul truck management system.

20. The system according to claim 17, wherein determining the estimated time of arrival includes:
receiving historical location data from one or more haul trucks that have previously traversed a path between the material plant and the destination, the historical location data including an average amount of time for the one or more haul trucks to traverse the path; and
retrieving traffic data corresponding to the path between the material plant and the destination at the check-out time, wherein the estimated time of arrival is determined based on the average time and the traffic data corresponding with the path.
